(19) United States
(12) Patent Application Publication
(10) Pub. No.: US 2009/0048930 A1
(43) Pub. Date: Feb. 19, 2009

(54) Wireless transmission and reception of information relating to an item advertised on a sign

(75) Inventor: Patrick Taylor, Redmond, WA (US)

Correspondence Address: NIXON & VANDERHYE, P.C., 901 NORTH GLEBE ROAD, 11TH FLOOR, ARLINGTON, VA, 22203, US

(73) Assignee: Nintendo of America Inc., Redmond, WA (US)

(21) Appl. No.: 12/222,786

(22) Filed: Aug. 15, 2008

Related U.S. Application Data
(60) Provisional application No. 60/935,532, filed on Aug. 17, 2007.

(51) Int. Cl. G06Q 30/00

(52) U.S. Cl. 705/14

(57) ABSTRACT

A transmitter is coupled to a sign advertising a product such as a house or car for sale. The transmitter wirelessly broadcasts visually displayable information relating to the advertised product to one or more portable, hand-held machines. A portable machine receiving the wirelessly broadcasted information may then store and display information about the advertised product such as price, textual description of product features, product photos or pictures, and salesperson's name and contact information with minimal time and effort and maximal convenience.

### TECHNOLOGICAL FIELD

The technology herein relates to methods and apparatuses for information creation, transmission and receipt. More particularly, the technology herein relates to methods and apparatuses for creation, wireless transmission and receipt of data describing an item being advertised on a sign.

### BACKGROUND AND SUMMARY

In the modern era, people are constantly seeking faster, more streamlined ways of accomplishing tasks. In particular, people are constantly seeking ways to obtain information, goods and services in a faster, easier and more efficient manner. For example, movies can now be ordered online or ordered directly to a television, and entire trips to a grocery store or mall can be bypassed through the use of digital shopping. These tasks may be accomplished without leaving a person's residence.

Certain tasks, however, have not caught up to the “high-speed” age, and must typically be performed in person. For example, before buying a car, many customers would still like to test drive it at least once, especially if the car is a used one. Even if a website states “facts” about a car, many customers still want to verify those facts in person before making a purchasing decision. Similarly, purchases of other large-cost items such as computers and televisions are often done in person since many customers want to see the product in person before making such a large purchase. This is particularly true for what is probably most people's largest purchase, their house, especially given the unique nature of a house (e.g., the one of a kind land on which it resides).

When shopping in person, certain undesirable issues may arise. For example, a customer shopping for a house or car or other large-cost item may be forced to schedule an appointment to inspect or obtain information about the item, thereby restricting convenience. A salesperson may put undue pressure on the customer to make a purchasing decision. Additionally, when shopping for a house, it may not be easy to determine in advance what houses are available in a certain area and thus determine in advance where specifically to go. If a customer sees one or more houses that he may be interested in purchasing, he may be forced to stop at each one and write down contact information, and/or leave the vehicle in which he is traveling to obtain a paper flyer describing the house. All of these actions take time and effort. As a result, a customer may not be able to view as a many houses in a given period of time. Further, if the owner or salesperson isn't available, a customer may not be able to find any relevant information describing the house until an appointment is scheduled, which can possibly take weeks if schedules don't coordinate. Convenience, time and effort may thus be lost.

It will thus be appreciated that there is a need in the art to resolve one or more of the above-noted issues. Exemplary illustrative non-limiting implementations provide such resolution. According to one exemplary illustrative non-limiting implementation, a transmitter is coupled to a sign advertising a product (e.g., a house or car for sale), and wirelessly broadcasts visually displayable information relating to the advertised product to one or more portable machines. A portable machine (e.g., a hand-held Nintendo DS® machine) receiving the wirelessly broadcasted information may then store and display it so that the portable machine's user can retrieve and view information about the product such as, but not limited to, price, textual description of product features, product photos, salesperson's name and contact information, etc. A customer may thus be able to efficiently receive, store and view a significant amount of information about the advertised product using his portable machine with a minimal amount of time and effort and a maximal amount of convenience. In particular, the customer may obtain, view and later retrieve product information without necessarily pre-arranging an appointment with a salesperson, without undue pressure from a salesperson, without having to write or hand-enter information, and without leaving his vehicle to obtain a paper flyer. Time, convenience and effort are therefore saved.

A customer may thus possess the time and energy needed to shop for additional products (e.g., other houses or cars) as the customer can move on to the next product quickly, while being confident that all of relevant information about a previously advertised product is safely stored for view on the portable machine or another computer system (e.g., an Nintendo Wii® Machine connected to a larger display monitor) in communication with the portable machine. The customer may ultimately have accumulated information of a complete collection of possible products stored on the portable machine. The stored information relating to each of the products may be easily sorted, compared and/or transferred to another computer system.

The information relating to the advertised product may be continuously or repeatedly (e.g., at periodic, regular intervals) broadcast from the transmitter. This continuous or repeated broadcast may be initiated by a user-operable switch coupled to the transmitter. Alternatively, transmission may be initiated in response to a request from one of the portable machines. The transmitter may download data to a plurality of portable machines in the manner described in co-pending, commonly owned U.S. application Ser. No. 11/504,111, the entire contents of which are incorporated herein by reference.

A memory associated with the transmitter may store the information relating to the advertised product. The memory may receive the information from another computer system such as the Nintendo Wii® system and store it for subsequent transmission by the transmitter. This other computer system may provide a potential seller with an easy-to-use application for creating the information relating to the product. For example, the application may upload pictures or photographs of a product, receive relevant textual information keyed-in by a user, and then organize this data into a pre-fabricated format using a computerized template. The organized data can then be transferred to the memory associated with the transmitter via a wired connection, a memory card or wireless transmission. The seller may therefore change and update information whenever desired. The seller may thus avoid a potentially complicated data entry or update into a product-selling website (e.g., a real-estate website), and may avoid potential delay while a requested update is processed by a webmaster of the product-selling website.

### BRIEF DESCRIPTION OF THE DRAWINGS

These and other objects, features, aspects and advantages of the present invention will become more apparent from the following detailed description of the present invention when taken in conjunction with the accompanying drawings, of which:

FIG. 1 shows an exemplary illustrative portable machine;

FIG. 2 shows an exemplary illustrative block diagram of the portable machine of FIG. 1;

FIG. 3 shows an exemplary illustrative transmission device in communication with a plurality of exemplary portable machines;

FIG. 4 shows an exemplary illustrative game apparatus;

FIG. 5 shows an exemplary illustrative block diagram showing an illustrative internal structure of the game apparatus of FIG. 4;

FIGS. 6A, 6B and 7 show different views of an exemplary illustrative non-limiting handheld controller for the game apparatus of FIG. 4;

FIG. 8 shows an exemplary illustrative block diagram of an exemplary illustrative non-limiting implementation of the handheld controller for the game apparatus of FIG. 4;

FIG. 9 shows an exemplary illustrative sign advertising an item or service provided with an exemplary transmission device;

FIG. 10 shows an exemplary screen displayed on a portable machine for prompting an information download from the transmission device;

FIG. 11 shows a second exemplary viewing screen displayed on a portable machine;

FIG. 12 is a flow diagram depicting one method of operation of portable machine for wirelessly downloading information from a transmission device;

FIG. 13 shows an exemplary screen shown on a display attached to a game apparatus which has received information from a portable machine;

FIG. 14 shows a first exemplary screen on a display attached to a game apparatus for enabling information to be entered for subsequent transfer to the transmission device; and

FIG. 15 shows a second exemplary screen on a display attached to a game apparatus for enabling information (e.g., digital photographs) to be uploaded for subsequent transfer to the transmission device.

### DETAILED DESCRIPTION OF THE ILLUSTRATIVE IMPLEMENTATIONS

The methods and apparatuses described herein can be used as a part of any system including at least a portable machine capable of wireless communication and a transmitter, with some of the methods and apparatuses additionally including a computer system, such as computerized game apparatus, connected to a display. While, exemplary illustrative non-limiting implementations are described below, other implementations are contemplated.

### Exemplary Portable Machine and Transmission Device

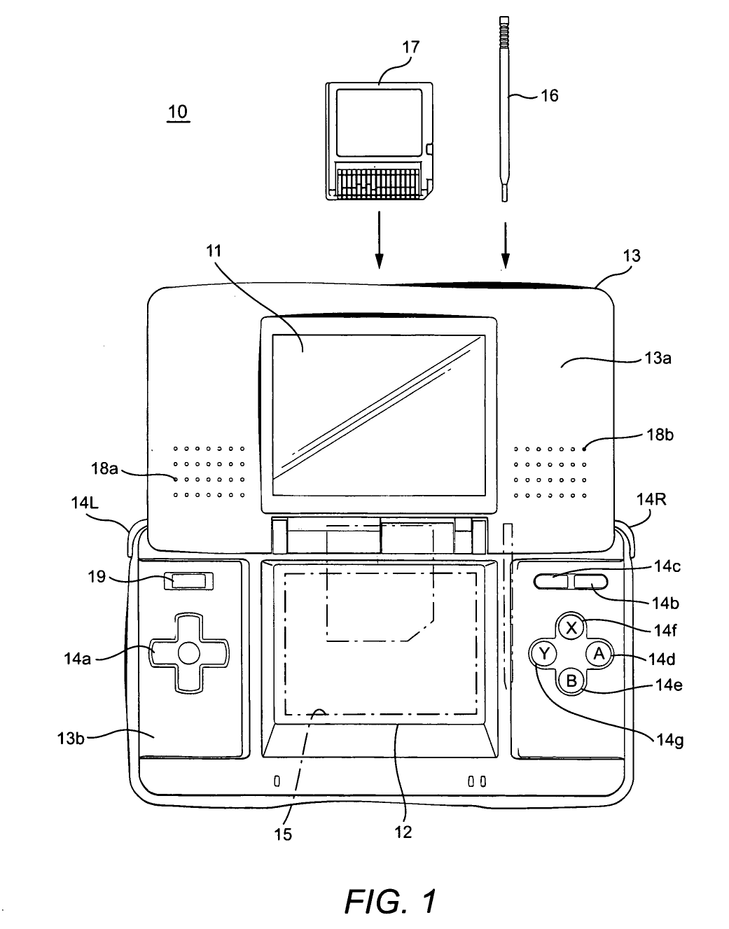

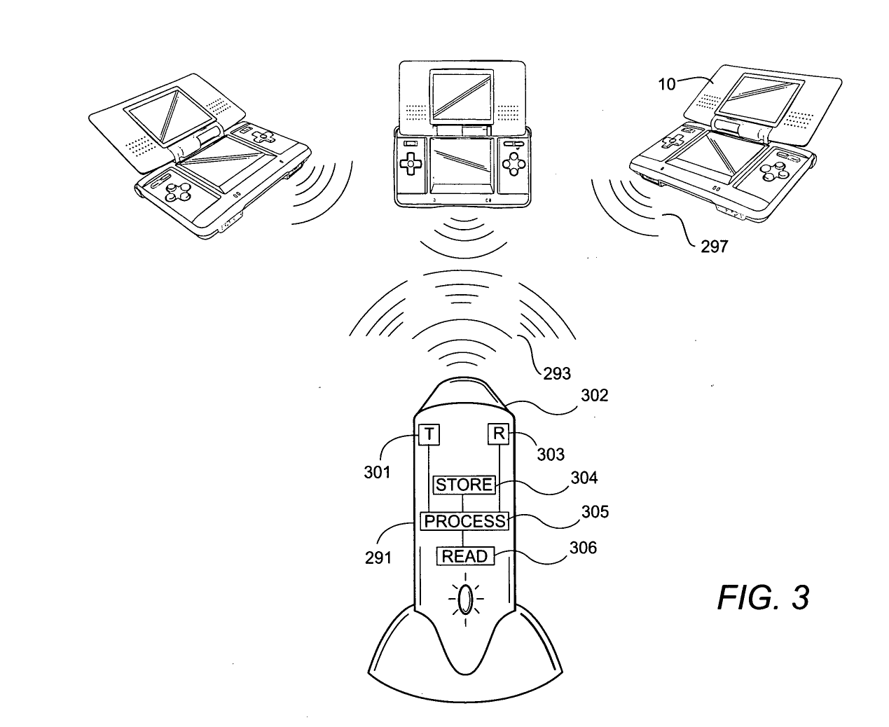

Referring now more particularly to the drawings, FIG. 1 is an external view of a hand-held portable machine 10 included in the wireless network system shown in FIG. 3. In accordance with the exemplary illustrative non-limiting implementation shown in FIG. 1, the portable machine 10 includes a first liquid crystal display (LCD) 11 and a second LCD 12. A housing 13 comprises an upper housing 13a and a lower housing 13b. The first LCD 11 is disposed in the upper housing 13a, and the second LCD 12 is disposed in the lower housing 13b. Each of the first and second LCDs 11 and 12 has a resolution of 256 dots×192 dots. Although the present illustrative portable machine 10 shows an example where LCDs 11, 12 are used as display devices, any other display devices, such as display devices using, for example, electroluminescence (EL) technology, can be used. Also, a portable machine 10 having display devices of any level of resolution and/or having a single display screen can be used.

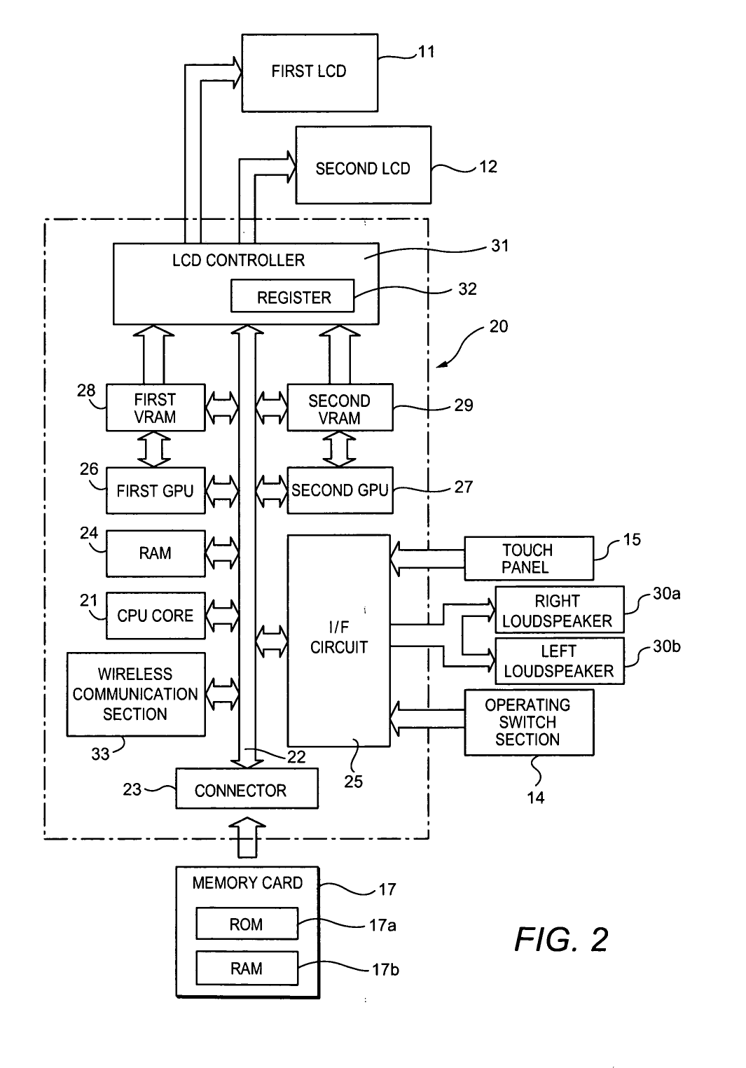

The upper housing 13a has formed therein sound holes 18a and 18b for emitting sound from a pair of loudspeakers (30a and 30b in FIG. 2, which will be described below). The lower housing 13b is provided with input mechanisms, such as, for example, a cross switch 14a, a start switch 14b, a select switch 14c, an “A” button 14d, a “B” button 14e, an “X” button 14f, a “Y” button 14g, an “L” button 14L, and an “R” button 14R. Also, a further input mechanism (touch panel 15) is mounted on the screen of the second LCD 12. The lower housing 13b is provided with a power switch 19 and insertion slots for receiving a memory card 17 and a stylus 16. The stylus 16 is used for input operations on the touch panel 15.

The memory card 17 is a storage medium having stored therein an operation program and a wireless communication program. The memory card is removably loaded into an insertion slot provided in the lower housing 13b.

The internal configuration of the portable machine 10 will be described with reference to FIG. 2. In FIG. 2, a CPU core 21 is mounted on an electronic circuit board 20, which is disposed in the housing 13. Via a bus 22, the CPU core 21 is connected to a connector 23, an input/output interface circuit 25 (labeled “I/F CIRCUIT” in FIG. 2), a first graphics processing unit (GPU) 26, a second GPU 27, a RAM 24, an LCD controller 31, and a wireless communication section 33. The memory card 17 is detachably connected to the connector 23. The memory card 17 includes a ROM 17a, which has stored therein a game program and a wireless communication program, and a RAM 17b, which has retrievably stored backup data stored therein. The game program and the wireless communication program, which are stored in the ROM 17a of the memory card 17, are loaded on to the RAM 24, and executed by the CPU core 21. In addition to the operation program and the wireless communication program, the RAM 24 stores temporary data, which is obtained by the CPU core 22 for executing the operation program, and data for generating an image. The I/F circuit 25 is operably connected to the touch panel 15, a right loudspeaker 30a, a left loudspeaker 30b, and an operation switch section 14 (shown in FIG. 1, including the cross switch 14a, the “A” button 14d, etc). The right loudspeaker 30a and the left loudspeaker 30b are placed inside the sound holes 18a and 18b.

Although the example illustrates the portable machine 10 having only one CPU core, the machine is not so limited. For example, the portable machine 10 may be provided with a plurality of CPU cores which share processes by the CPU core 21.

The first GPU 26 is connected to a first video-RAM (VRAM) 28. The second GPU 27 is connected to a second VRAM 29. In accordance with an instruction from the CPU core 21, the first GPU 26 generates a first image on the basis of data used for image generation stored in the RAM 24, and writes the image into the first VRAM 28. Similarly, in accordance with an instruction from the CPU core 21, the second GPU 27 generates a second image, and writes the image into the second VRAM 29. The first and second VRAMs 28 and 29 are connected to the LCD controller 31.

The LCD controller 31 includes a register 32. The register 32 stores a value of 0 or 1 in accordance with an instruction from the CPU core 21. If the value in the register 32 is 0, the LCD controller 31 outputs to the first LCD 11 the first image written on the first VRAM 28, and also outputs to the second LCD 12 the second image written on the second VRAM 29. Alternatively, if the value of the register 32 is 1, the first image written on the first VRAM 28 is output to the second LCD 12, and the second image written on the second VRAM 29 is output to the first LCD 11.

The wireless communication section 33 is operable to exchange processes and other data with a wireless communication section 33 of another portable machine or other wireless machine (e.g., wireless transmission device 291). In the present illustrative device, it is assumed that a wireless communication section has a radio communication function in conformity with, for example, IEEE 802.11 wireless LAN standards.

It will be appreciated that the above-described configuration of the portable machine 10 is merely illustrative and should not be construed as limiting. Also, the game program and wireless communication program may be supplied to the portable machine 10 not only via an external storage medium, such as the memory card 17, but also via a wired or wireless communication channel. Alternatively or in addition, the game program and wireless communication program may be previously stored in a nonvolatile storage device within the portable machine 10.

According to one aspect of the exemplary illustrative non-limiting implementations, as shown in FIG. 3, a transmission device 291 (e.g., a server) is provided to serve out copies of files to one or more portable machines 10. The transmission device 291 is configured to communicate wirelessly 293 with the machines 10, and the machines 10 are also provided with wireless communication 297 capability. The transmission device 291 includes, among other things, a data transmission section 301, a data reception section 302, a memory 303 for storing data, a processor 304, a memory card reader 305 and a user-operable activation switch 306. Operation of these components will be discussed below.

### Exemplary Video Game Apparatus

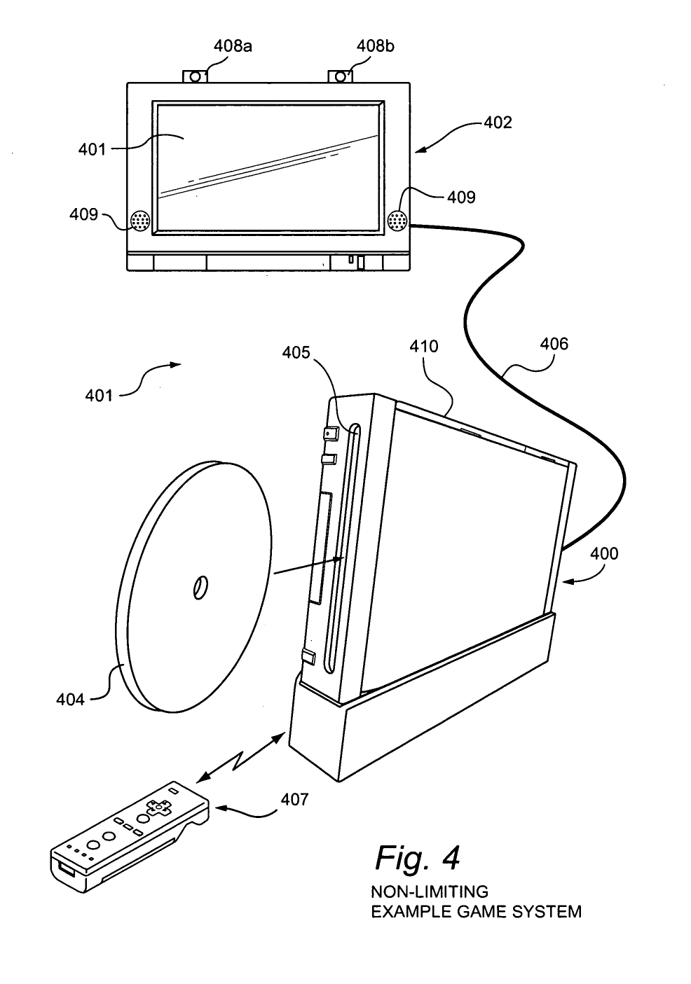

FIG. 4 shows a non-limiting example game system 401 including a game apparatus 400, a television or other display 402 and a handheld controller 407.

Game apparatus 400 executes a game program and other applications (e.g., an application for communicating data to the server 291 and/or at least one of the portable game machines 10 as will be discussed in more detail below) stored on optical disc 404 or other memory media inserted into slot 405 formed in housing 410 thereof. The game program (or other applications) execution result is displayed on display 402 to which game apparatus 400 is connected by cable 406 or otherwise. Audio associated with the game program or other application is output via television speakers 409. While an optical disk is shown in FIG. 4 for use in storing video game software, the game program or other application may alternatively or additionally be stored on other storage media such as semiconductor memories, magneto-optical memories, magnetic memories and the like and/or downloaded over a network or by other means.

An exemplary illustrative non-limiting handheld controller implementation 407 wirelessly transmits data such as game control (and other) data to the game apparatus 400. The game control data and other data such as textual information describing an item or service may be generated using an operation section of controller 407. Controller 407 may also wirelessly receive data transmitted from game apparatus 400. Any one of various wireless protocols such as Bluetooth®, RF, IR or other protocols may be used for the wireless transmissions between controller 407 and game apparatus 400.

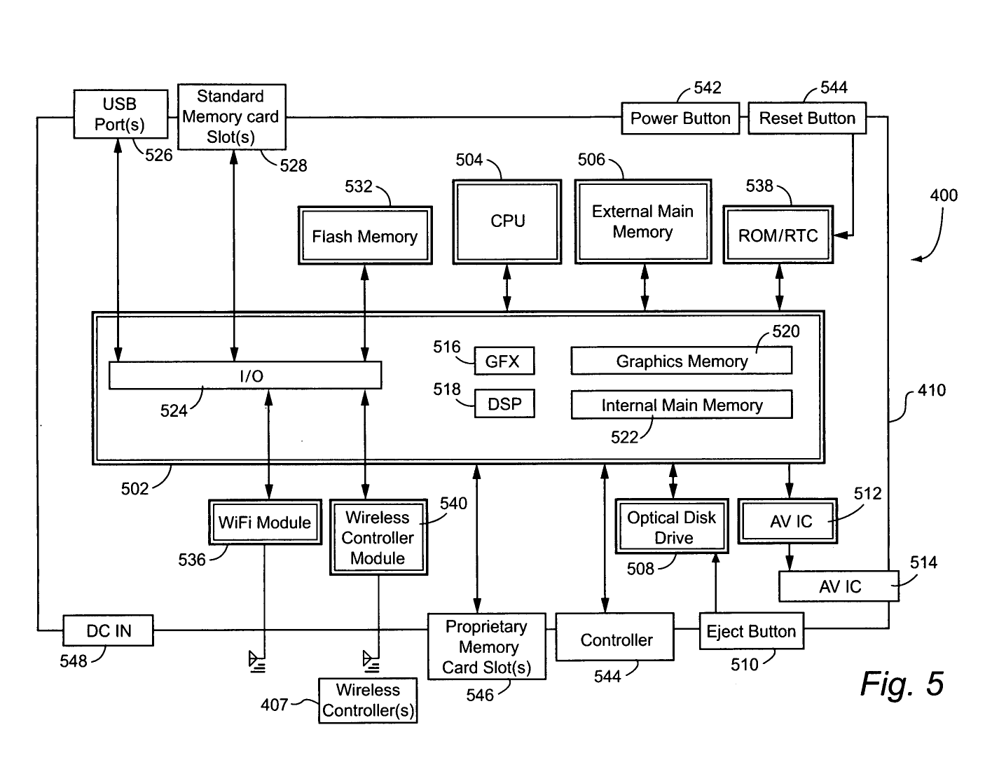

Exemplary controller 407 also includes an imaging information calculation section (FIG. 5) for capturing and processing images from light-emitting devices 408a and 408b associated with display 402. A center point between light-emitting devices 408a and 408b may be aligned with a vertical center line of display 402. The images from light-emitting devices 408a and 408b can be used to determine a direction in which controller 407 is pointing as well as a distance of controller 407 from display 402. By way of example without limitation, light-emitting devices 408a and 408b may be implemented as two LED modules (hereinafter, referred to as “markers”) provided in the vicinity of a display screen 402. The markers each output infrared light. The imaging information calculation section of controller 407 detects the light output from the LED modules to determine a direction in which controller 407 is pointing and a distance of controller 407 from display 402. Although markers 408a and 408b are shown in FIG. 4 as being above television 402, they may also be positioned below television 402 or in other configurations.

With reference to the block diagram of FIG. 5, an exemplary illustrative non-limiting game apparatus 400 includes a RISC or other central processing unit (CPU) 504 for executing various types of applications including (but not limited to) video game programs. CPU 504 executes a boot program stored in a boot ROM (not shown) to initialize game apparatus 400, and then executes an application (or applications) stored on optical disc 404 which is inserted in optical disk drive 405.

In one example implementation, optical disk drive 405 receives both optical disks of a first type (e.g., of a first size and/or of a first data structure, etc.) containing applications developed for execution by CPU 504 and graphics processor 516 and optical disks of a second type (e.g., of a second size and/or a second data structure) containing applications originally developed for execution by a different CPU and/or graphics processor. For example, the optical disks of the second type may be applications originally developed for the Nintendo GameCube® platform.

CPU 504 is connected to system LSI 502 that includes graphics processing unit (GPU) 516 with an associated graphics memory 520, audio digital signal processor (DSP) 518, internal main memory 522 and input/output (IO) processor 524.

IO processor 524 of system LSI 502 is connected to one or more USB ports 526, one or more standard memory card slots (connectors) 528, WiFi or other wireless or other LAN module 530, flash memory 532 and wireless controller module 540.

USB ports 526 are used to connect a wide variety of external devices to game apparatus 400. These devices include, by way of example without limitation, game controllers, keyboards, storage devices such as external hard-disk drives, printers, digital cameras, and the like. USB ports 526 may also be used for wired network (e.g., LAN) connections. In one example implementation, two USB ports 526 are provided, but other configurations are possible.

Standard memory card slots (connectors) 528 are adapted to receive industry-standard-type memory cards (e.g., SD memory cards) in one exemplary illustrative non-limiting example. In one example implementation, one memory card slot 528 is provided. These memory cards are generally used as data carriers. For example, a user may store game data for a particular game or textual and photographic data describing an item or service for another application on a memory card and bring the memory card to a to another game apparatus. The memory cards may also be used to transfer data between the game apparatus and personal computers, digital cameras, portable machines 10 and the like. As yet another example, the memory card may be inserted into transmission device 291 and read by card reader 305 for processing by processor 304 and storage by memory 303. Flash memory 532 stores, by way of example without limitation, game save data, system files, internal applications for the apparatus and downloaded data (such as games).

WiFi module 536 enables game apparatus 400 to be connected to a wireless access point. The access point may provide internet connectivity for on-line gaming with players at other locations (with or without voice chat capabilities), as well as web browsing, e-mail, file uploads or downloads (including game downloads) and many other types of on-line activities. In some implementations, WiFi module 536 may also be used for communication with other game devices such as suitably-equipped hand-held game devices. Module 536 is referred to herein as “WiFi”, which is generally used in connection with the family of IEEE 802.11 specifications. However, game apparatus 400 may alternatively or additionally use wireless modules that conform to other wireless or wired standards.

Wireless controller module 540 receives signals wirelessly transmitted from one or more controllers 407 and provides these received signals to IO processor 524. Any number of separate controllers may be used to provide multi-player inputs. The signals transmitted by controller 407 to wireless controller module 540 may include signals generated by controller 407 itself as well as by other devices that may be connected to controller 407. By way of example, some games may utilize separate right- and left-hand inputs. For such games, another controller (not shown) may be connected to controller 407 and controller 407 could transmit signals generated by itself and by the other controller to wireless controller module 540.

Wireless controller module 540 may also wirelessly transmit signals to controller 407. By way of example without limitation, controller 407 (and/or another game controller connected thereto) may be provided with vibration circuitry and vibration circuitry control signals may be sent via wireless controller module 540 to control the vibration circuitry. By way of further example without limitation, controller 407 may be provided with (or be connected to) a speaker (not shown) and audio signals for output from this speaker may be wirelessly communicated to controller 407 via wireless controller module 540. By way of still further example without limitation, controller 407 may be provided with (or be connected to) a display device (not shown) and display signals for output from this display device may be wirelessly communicated to controller 407 via wireless controller module 540 or otherwise.

Proprietary memory card slots 546 are adapted to receive proprietary memory cards. In one example implementation, two such slots are provided. These proprietary memory cards have some non-standard feature such as a non-standard connector or a non-standard memory architecture. For example, one or more of the memory card slots 546 may be adapted to receive memory cards developed for the Nintendo GameCube® or other platform. In this case, memory cards inserted in such slots can transfer data from games developed for the GameCube® or other platform. In an example implementation, memory card slots 546 may be used for read-only access to the memory cards inserted therein and limitations may be placed on whether data on these memory cards can be copied or transferred to other storage media such as standard memory cards inserted into slots 528.

One or more controller connectors 544 are adapted for wired connection to respective game controllers. In one example implementation, four such connectors are provided for wired connection to game controllers for the Nintendo GameCube® platform. Alternatively, connectors 544 may be connected to respective wireless receivers that receive signals from wireless game controllers. These connectors enable players, among other things, to use controllers for the Nintendo GameCube® platform when an optical disk for a game developed for this platform is inserted into optical disk drive 508.

A connector 548 is provided for connecting game apparatus 400 to DC power derived, for example, from an ordinary wall outlet. Of course, the power may be derived from one or more batteries or by any other desired means.

GPU 516 performs image processing based on instructions from CPU 504. GPU 516 includes, for example, circuitry for performing calculations and operations for displaying textured and/or shaded three-dimensional (3D) graphics. GPU 516 performs image processing using graphics memory 520 (which may be dedicated for image processing) and internal main memory 522. GPU 516 generates image data for output to television 402 by audio/video connector 514 via audio/video IC (interface) 512. External main memory 506 and internal main memory 522 are storage areas directly accessible by CPU 504. For example, these memories can store an application program such as a game program read from optical disc 404 by the CPU 504, various types of data or the like.

Audio DSP 518 performs audio processing based on instructions from CPU 504. The audio generated by audio DSP 518 is output to television 402 by audio/video connector 514 via audio/video IC 512.

ROM/RTC 538 includes a real-time clock and preferably runs off of an internal battery (not shown) so as to be usable even if no external power is supplied. ROM/RTC 538 also may include a boot ROM and SRAM usable by the apparatus.

Power button 542 is used to power game apparatus 400 on and off. In one example implementation, power button 542 is depressed for a specified time (e.g., one or two seconds) to turn the apparatus off so as to reduce the possibility of inadvertent turn-off. Reset button 544 is used to reset (re-boot) game apparatus 400.

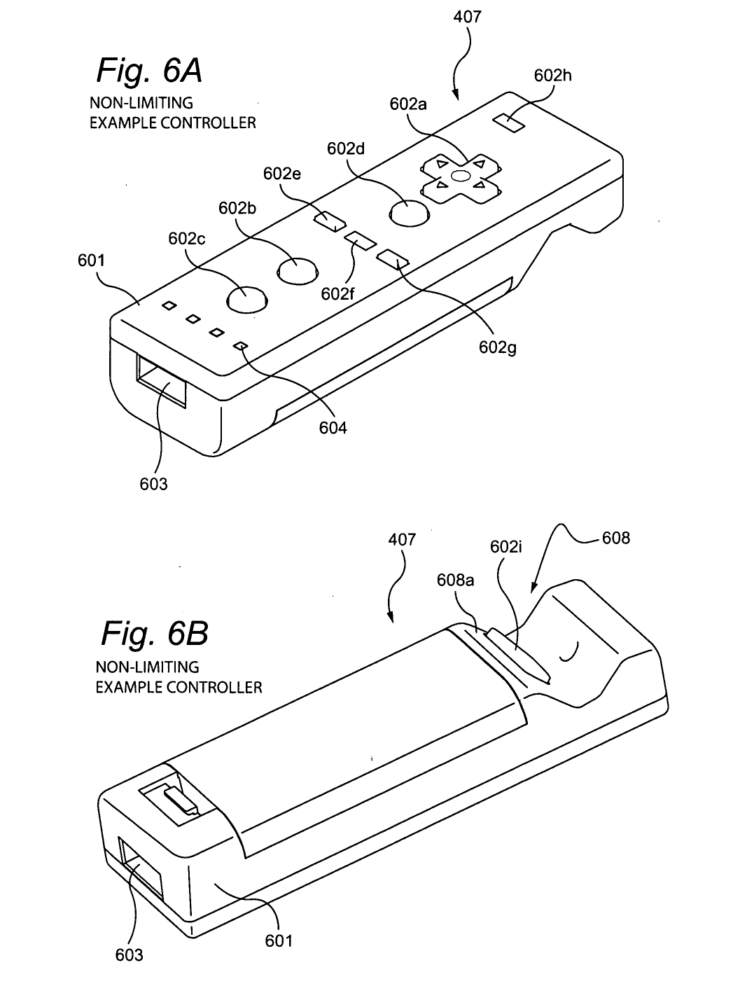

With reference to FIGS. 6A, 6B and 7, example controller 407 includes a housing 601 on which operating controls 602a-602h are provided. Housing 601 has a generally elongated rectangular shape and is sized to be conveniently holdable in a player's hand. Cross-switch 602a is provided at the center of a forward part of a top surface of the housing 601. Cross-switch 602a is a cross-shaped four-direction push switch which includes operation portions corresponding to the directions designated by the arrows (front, rear, right and left), which are respectively located on cross-shaped projecting portions. A player selects one of the front, rear, right and left directions by pressing one of the operation portions of the cross-switch 602a. By actuating cross-switch 602a, the player can, for example, move a character in different directions in a virtual game world, control a cursor, attack an enemy, etc.

Cross-switch 602a is described by way of example. Other types of operation sections may be used. By way of example without limitation, a composite switch including a push switch with a ring-shaped four-direction operation section and a center switch may be used. By way of further example without limitation, any or all of the following may be used:

an inclinable stick such as a joystick projecting from the top surface of housing 601 that outputs signals in accordance with the inclining direction of the stick;

a horizontally slidable disc-shaped member that outputs signals in accordance with the sliding direction of the disc-shaped member;

a touch pad; and

separate switches corresponding to at least four directions (e.g., front, rear, right and left) that output respective signals when pressed by a player.

In one exemplary illustrative non-limiting implementation, buttons (or keys) 602b through 602g are provided rearward of cross-switch 602a on the top surface of housing 601. Buttons 602b through 602g are operation devices that output respective signals when a player presses them. For example, buttons 602b through 602d are respectively an “X” button, a “Y” button and a “B” button. Buttons 602e through 602g are respectively a select switch, a menu switch and a start switch, for example. Generally, buttons 602b through 602g are assigned various (variable) functions in accordance with the application being executed by game apparatus 400. In an exemplary arrangement shown in FIGS. 6A, 6B, buttons 602b through 602d are linearly arranged along a front-to-back centerline of the top surface of housing 601. Buttons 602e through 602g are linearly arranged along a left-to-right line between buttons 602b and 602d. Button 602f may be recessed from a top surface of housing 601 to reduce the possibility of inadvertent depression by a player grasping controller 407.

Button 602h is provided forward of cross-switch 602a on the top surface of the housing 601. Button 602h is a power switch for remote on-off switching of the power to game apparatus 400. Button 602h may also be recessed from a top surface of housing 601 to reduce the possibility of inadvertent depression.

In one exemplary illustrative non-limiting implementation, a plurality (e.g., four) of LEDs 604 is provided rearward of button 602c on the top surface of housing 601. Controller 407 is assigned a controller type (number) so as to be distinguishable from the other controllers used with game apparatus 400 in a multiplayer context. LEDs 604 may be used to provide a player a visual indication of his or her assigned controller number. For example, when controller 407 transmits signals to wireless controller module 540, one of the plurality of LEDs corresponding to the controller type is lit up.

With reference to FIG. 6B, a recessed portion 608 is formed on a bottom surface of housing 601. Recessed portion 608 is positioned so as to receive an index finger or middle finger of a player holding controller 407. A button 602i is provided on a rear, sloped surface 608a of the recessed portion. Button 602i functions, for example, as an “A” button which can be used, by way of illustration, as a trigger switch in a shooting or other game.

As shown in FIG. 7, an imaging element 605a is provided on a front surface of controller housing 601 in one exemplary illustrative non-limiting implementation. Imaging element 605a is part of an imaging information calculation section of controller 407 that analyzes image data received from markers 408a and 408b. Imaging information calculation section 605 has a maximum sampling period of, for example, about 200 frames/sec., and therefore can trace and analyze even relatively fast motion of controller 407.

Connector 603 is provided on a rear surface of controller housing 601. Connector 603 is used to connect devices to controller 407. For example, a second controller of similar or different configuration may be connected to controller 407 via connector 603 in order to allow a player to play games or operate other applications using game control inputs from both hands. Other devices including game controllers for other game apparatuses, input devices such as keyboards, keypads, touchpads and output devices such as speakers and displays may be connected to controller 407 using connector 603 or by other means.

For ease of explanation in what follows, a coordinate system for controller 407 will be defined. As shown in FIGS. 6A, 6B and 7, a left-handed X, Y, Z coordinate system has been defined for controller 407. Of course, this coordinate system is described by way of example without limitation and the systems and methods described herein are equally applicable when other coordinate systems are used.

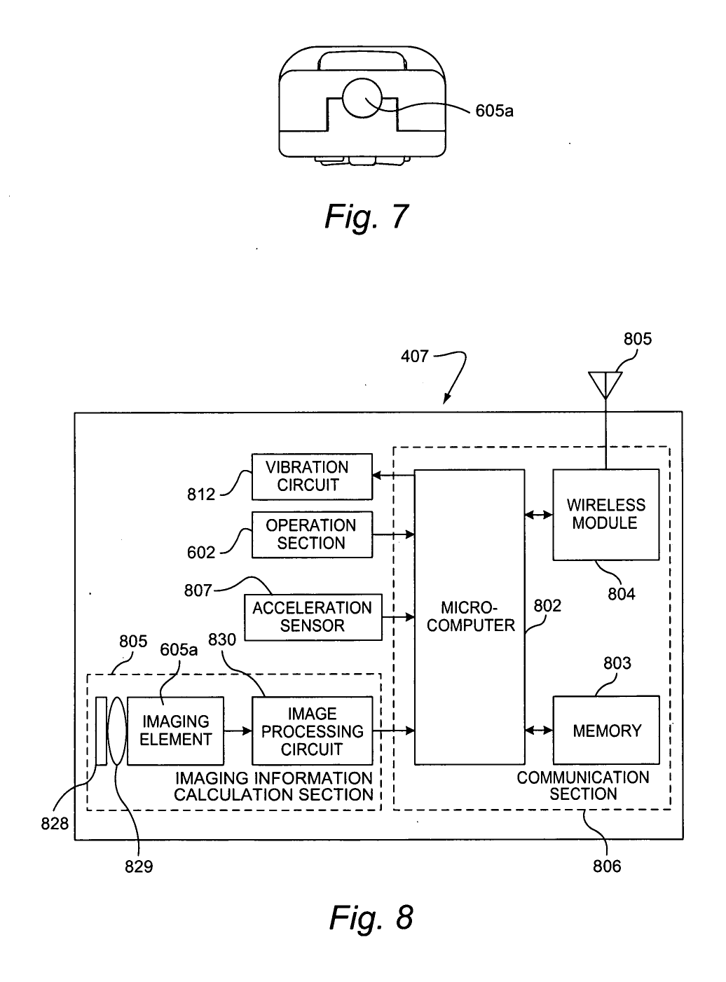

As shown in the block diagram of FIG. 8, controller 407 includes a three-axis, linear acceleration sensor 807 that detects linear acceleration in three directions, i.e., the up/down direction (Z-axis shown in FIGS. 6A, 6B and 7), the left/right direction (X-axis shown in FIGS. 6A, 6B and 7), and the forward/backward direction (Y-axis shown in FIGS. 6A, 6B and 7). Alternatively, a two-axis linear accelerometer that detects only linear acceleration along each of the Y-axis and Z-axis may be used or a one-axis linear accelerometer that detects only linear acceleration along the Z-axis may be used. Generally speaking, the accelerometer arrangement (e.g., three-axis or two-axis) will depend on the type of control signals desired. As a non-limiting example, the three-axis or two-axis linear accelerometer may be of a type available from Analog Devices, Inc. (ADXL303) or STMicroelectronics N.V. Preferably, acceleration sensor 807 is an electrostatic capacitance or capacitance-coupling type that is based on silicon micro-machined MEMS (micro-electromechanical systems) technology. However, any other suitable accelerometer technology (e.g., piezoelectric type or piezoresistance type) now existing or later developed may be used to provide three-axis or two-axis linear acceleration sensor 807.

As one skilled in the art understands, linear accelerometers as used in acceleration sensor 807 are capable of detecting acceleration along a straight line corresponding to each axis of the acceleration sensor. In other words, the direct output of acceleration sensor 807 is limited to signals indicative of linear acceleration (static or dynamic) along each of the two or three axes thereof. As a result, acceleration sensor 807 in one exemplary illustrative non-limiting implementation cannot directly detect movement along a non-linear (e.g. arcuate) path, rotation, rotational movement, angular displacement, tilt, position, attitude or any other physical characteristic.

However, through additional processing of the linear acceleration signals output from acceleration sensor 807, additional information relating to controller 407 can be inferred or calculated (i.e., determined), as one skilled in the art will readily understand from the description herein. For example, by detecting static, linear acceleration (i.e., gravity), the linear acceleration output of acceleration sensor 807 can be used to determine tilt of controller 407 relative to the gravity vector by correlating tilt angles with detected linear acceleration. In this way, acceleration sensor 807 can be used in combination with micro-computer 802 of controller 407 (or another processor) to determine tilt, attitude or position of controller 407. Similarly, various movements and/or positions of controller 407 can be calculated through processing of the linear acceleration signals generated by acceleration sensor 807 when controller 407 containing acceleration sensor 807 is subjected to dynamic accelerations by, for example, the hand of a user.

In other exemplary illustrative non-limiting implementations, acceleration sensor 807 may include an embedded signal processor or other type of dedicated processor for performing any desired processing of the acceleration signals output from the accelerometers therein prior to outputting signals to micro-computer 802. For example, the embedded or dedicated processor could convert the detected acceleration signal to a corresponding tilt angle (or other desired parameter) when the acceleration sensor is intended to detect static acceleration (i.e., gravity). Controllers not equipped with motion sensing technology can also be used with the exemplary illustrative non-limiting implementations.

FIG. 8 shows image information calculation section 805 of controller 407 as including infrared filter 828, lens 829, imaging element 605a and image processing circuit 830. Infrared filter 828 allows only infrared light to pass therethrough from the light that is incident on the front surface of controller 407. Lens 829 collects and focuses the infrared light from infrared filter 828 on imaging element 605a. Imaging element 605a is a solid-state imaging device such as, for example, a CMOS sensor or a CCD. Imaging element 605a captures images of the infrared light from markers 408a and 408b collected by lens 629. Accordingly, imaging element 605a captures images of only the infrared light that has passed through infrared filter 828 and generates image data based thereon. This image data is processed by image processing circuit 820 which detects an area thereof having high brightness, and, based on this detecting, outputs processing result data representing the detected coordinate position and size of the area to communication section 806. From this information, the direction in which controller 407 is pointing and the distance of controller 407 from display 402 can be determined. Controllers not equipped with light detecting technology can also be used with the exemplary illustrative non-limiting implementations.

Vibration circuit 812 may also be included in controller 407. Vibration circuit 812 may be, for example, a vibration motor or a solenoid. Controller 407 is vibrated by actuation of the vibration circuit 812 (e.g., in response to signals from game apparatus 400), and the vibration is conveyed to the hand of the player holding controller 407. Thus, a so-called vibration-responsive game may be realized.

As described above, acceleration sensor 807 detects and outputs the acceleration in the form of components of three axial directions of controller 407, i.e., the components of the up-down direction (Z-axis direction), the left-right direction (X-axis direction), and the front-rear direction (the Y-axis direction) of controller 407. Data representing the acceleration as the components of the three axial directions detected by acceleration sensor 807 is output to communication section 806. Based on the acceleration data which is output from acceleration sensor 807, motion of controller 407 can be determined.

In one exemplary illustrative non-limiting implementation, communication section 806 includes micro-computer 802, memory 803, wireless module 804 and antenna 805. Micro-computer 802 controls wireless module 804 for transmitting and receiving data while using memory 803 as a storage area during processing. Micro-computer 802 is supplied with data including operation signals (e.g., cross-switch, button or key data) from operation section 602, acceleration signals in the three axial directions (X-axis, Y-axis and Z-axis direction acceleration data) from acceleration sensor 807, and processing result data from imaging information calculation section 805. Micro-computer 802 temporarily stores the data supplied thereto in memory 803 as transmission data for transmission to game apparatus 400. The wireless transmission from communication section 806 to game apparatus 400 is performed at a predetermined time interval. Because game processing is generally performed rapidly at for example a cycle of 1/60 sec. (16.7 ms), the wireless transmission is preferably performed at a cycle of a shorter time period. For example, a communication section structured using Bluetooth® technology can have a cycle of 5 ms. At transmission time, micro-computer 802 outputs the transmission data stored in memory 803 as a series of operation information to wireless module 804.

Wireless module 804 uses, for example, Bluetooth® technology to send the operation information from antenna 805 as a carrier wave signal having a specified frequency. Thus, operation signal data from operation section 602, the X-axis, Y-axis and Z-axis direction acceleration data from acceleration sensor 807, and the processing result data from imaging information calculation section 805 are transmitted from controller 407. Game apparatus 400 receives the carrier wave signal and demodulates or decodes the carrier wave signal to obtain the operation information (e.g., the operation signal data, the X-axis, Y-axis and Z-axis direction acceleration data, and the processing result data). Based on this received data and the application currently being executed, CPU 504 of game apparatus 400 performs application processing. If communication section 806 is structured using Bluetooth® technology, controller 407 can also receive data wirelessly transmitted thereto from devices including game apparatus 400. Controllers 407 connected to a game apparatus or other device by a wire or other means may also be used with the exemplary illustrative non-limiting implementations.

Exemplary illustrative non-limiting methods and apparatuses for implementing a system using the transmission device 291, the portable machine 10 and the game apparatus 400, will now be disclosed.

Exemplary Distribution System

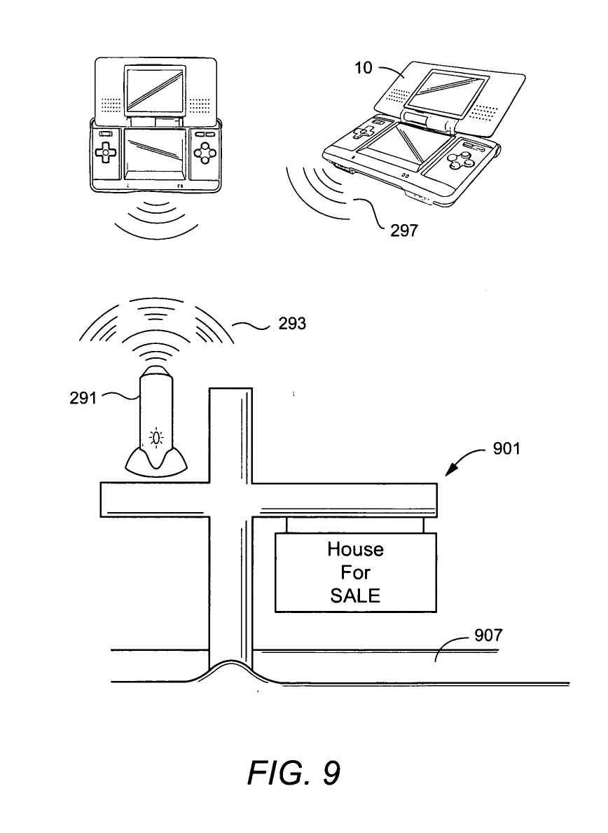

FIG. 9 shows a sign 901 advertising a house for sale and an attached transmission device 291 (see FIG. 3) in accordance with an exemplary illustrative non-limiting implementation. The transmission device 291 is mounted on a side of the sign 901. However, the transmission device 291 could alternatively be attached to any other portion of the sign 901 or be placed in or on the ground 907 adjacent to the sign 901, or at another location relatively close to the sign 901. As yet another alternative, the transmission device 291 could also be build into or as part of the sign 901 itself. While the sign 901 advertises sale of a house, the sign 901 could alternatively provide advertising for virtually any other item or service, such as a car for lease or sale.

According to this implementation, the transmission device 291 broadcasts information about the house for sale. The broadcast 293 may be initiated by user manipulation of a switch 306 of the transmission device 291 and/or upon receipt of a request from a portable machine 10 operated for example by a potential buyer. Once initiated, the broadcast 293 may continuously and/or repeatedly (i.e., at periodic intervals) provide the information from the transmission device 291 in a wireless manner. The transmission device 291 may further be configured to support rapid transmission to a multitude of portable machines 10 at once, as is disclosed in co-pending U.S. application Ser. No. 11/504,111 the content of which is incorporated herein by reference.

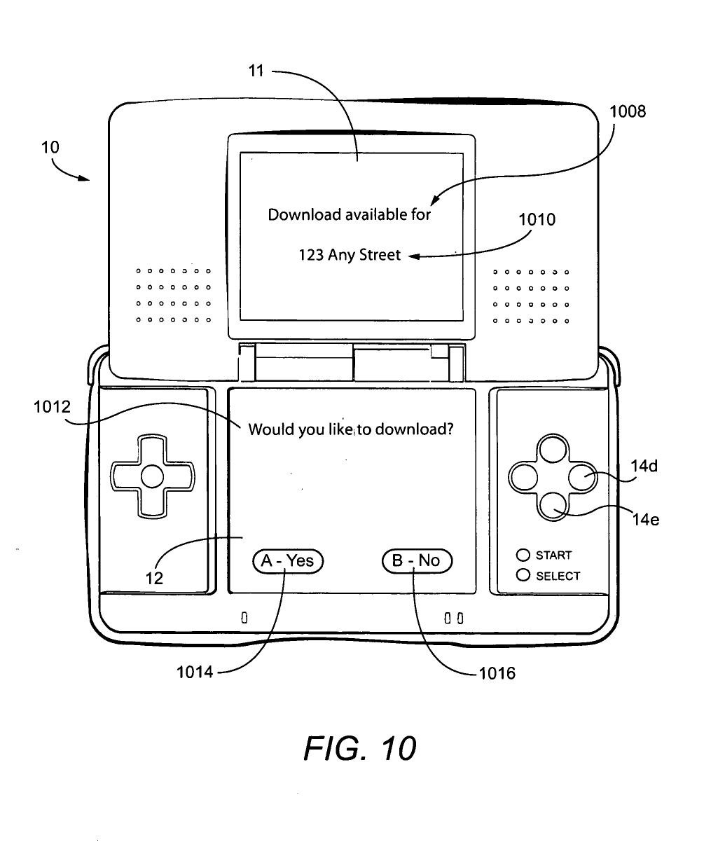

FIG. 10 shows an exemplary display of a portable machine 10 which is executing a specific program for downloading data from any transmission device 291. This program may be read from a memory card 17 or other usual computer-readable medium or permanently stored in, for example, an internal non-volatile memory in the portable machine 10. While the portable machine 10 is executing the data download program, the portable machine 10 may come within a transmission range of one or more of the transmission devices 291. When the portable machine 10 arrives within a transmission range of a transmission device 291 and hence detects the existence of data transmitted from the transmission device 291, a notification message 1008, 1010 is displayed on a first display 11 of the portable machine 10. Although the portable machine 10 disclosed herein has two displays 11 and 12, portable machines 10 with any number of displays are contemplated.

The notification message 1008, 1010 notifies a user of the portable machine 10 that a possible download is available. To receive the notification message, the portable machine 10 receives the notification message via execution of the data download program which, among other things, enables the portable machine 10 to actively look for available transmission devices 291. The message comprises two parts in this exemplary implementation, a generic portion 1008 and a specific portion 1010. The specific portion allows the user to know which information is being downloaded. For example, if the portable machine 10 is within the respective ranges of multiple transmission devices, but the portable machine's user was only interested in one house, the user may not want to download extra information that may later be confusing. Any type of notification message may be provided to the user, or the user may request a download and then the system may check to see if one is available.

On a second screen 12 of the portable machine 10, a second message 1012 is displayed. A multitude of option prompts 1014, 1016 can be provided to a user when the portable machine 10 detects the existence of data transmitted by the transmission device 291 when moving into the range of the transmission device 291. In this case, the options corresponding to option prompts 1014 and 1016 can be selected using A and B buttons 14d and 14e, respectively. The options can also be selected by touching the display 12 at any position within the option prompts 1014, 1016. A third option (not shown) could be a “not now” option, so that if a user declines a download, he can have the option to download the information later. Other options are also contemplated.

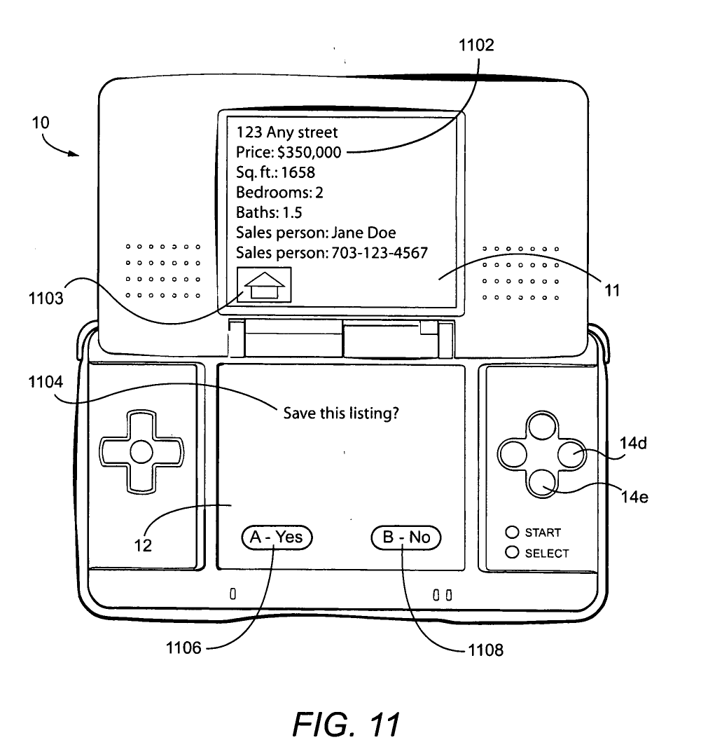

If the user selects yes to downloading data by selecting button 14d, the exemplary screens shown in FIG. 11 appear in displays 11 and 12 of the portable machine 10. On the upper display 11, an address, price, sq. footage, and bedroom/bathroom count and other textual information 1102 is shown. This information may also include one or more pictures or photographs 1103 of the house. Part(s) or all of the information shown in upper display 11 may instead be shown in lower display 12.

The user is also given a choice of whether or not to save the download 1104. For example, if the price was more than the user was willing to pay, the user might not want to fill up limited memory space of the portable machine 10 with the download, so the user would then select the “no” prompt 1108 and the downloaded file would be erased from the temporary memory. If the user instead selected the “yes” prompt 1106, the file might be saved to the removable memory card 17 or other memory device. The file might also be automatically saved to a removable memory card without providing a save/don't save option. As another alternative, the data transmitted from transmission device 291 may be automatically downloaded and displayed and also automatically saved by portable machine 10 when the portable machine 10 detects the existence of data transmitted by the transmission device 291. This will occur when the portable machine 10 becomes located within the transmission range of the transmission device 291.

As noted above, the portable machine 10 may wirelessly transmit a request for data to the transmission device 291. Upon receiving and processing the request (e.g., via receiving module 302 and processor 304), the transmission device 291 can begin broadcast 293 of the data relating to the house for sale. After receiving the data, the portable machine 10 can display the user-selectable prompts 1014, 1016 and subsequent user-selectable prompts 1106 and 1108 to display and save the transmitted data, or display and/or save the data in the portable machine 10 automatically. In this alternative exemplary embodiment, energy normally consumed via a continuous or repeated broadcast 293 from transmission device 291 may be saved since the broadcast will not begin until a request from a portable machine 10 is received by the transmission device 291. The portable machine 10 transmits the request for data upon user manipulation of the appropriate button, switch or touch screen on the portable machine 10.

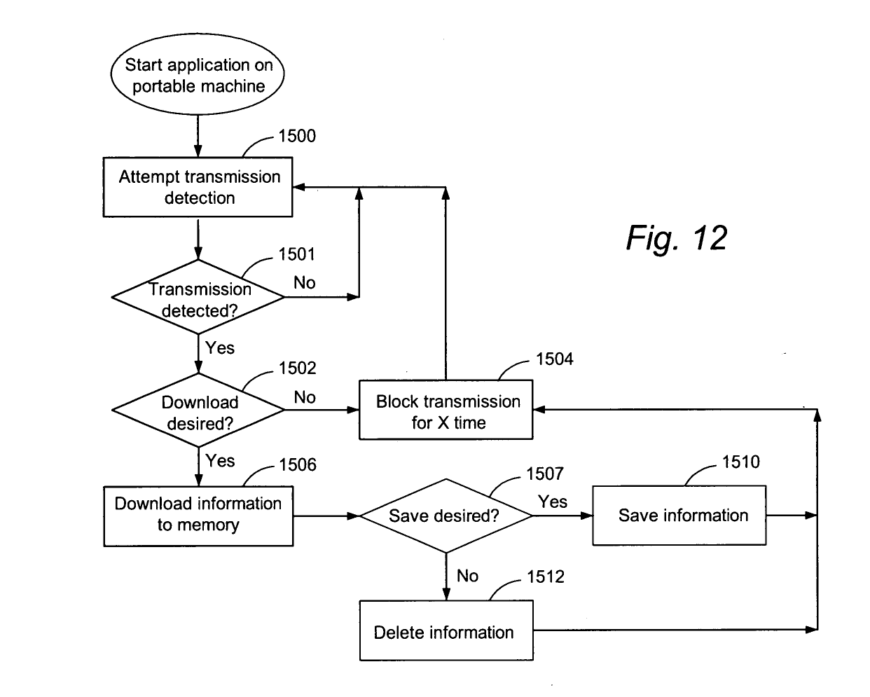

FIG. 12 shows one exemplary non-limiting method of operating a portable machine 10 to download information relating to the advertised item from the transmission device 291. When executing the appropriate application, the portable machine 10 attempts to detect the existence of a data transmission from the transmission device 291 (step 1500). If no transmission is detected (step 1501), the detection attempt of the portable machine 291 repeats in an execution loop. If transmission is detected (step 1501), the portable machine 10 provides appropriate display prompts and determines whether a user desires a download of the transmitted data based on a user response to the prompts as illustrated for example in FIG. 10 (step 1502). As an alternative embodiment, if transmission is detected (step 1501), the portable machine 10 automatically downloads the transmitted data without prompting the user.

If the user does not want a download, the portable machine 10 blocks transmission of the data for a certain period of time (step 1504). This blockage prevents a user from repeatedly being asked about a download. However, there are a variety of alternative ways to solve this problem.

If the download is desired, the information file is downloaded from the transmission device 291 into a memory (step 1506) of the portable machine. Alternatively, the download may be automatically performed upon detection of the transmitted data or after the transmission device 291 receives and processes a data download request from the portable machine 10. The user can view the file on display 11 or 12 of the portable machine 10. The user can also decide (step 1508) whether or not the file should be saved to a memory such as a storage card (step 1510) or deleted (step 1512). After either choice, the transmission is at least temporarily blocked (step 1504) so that the user is not repeatedly prompted with this download.

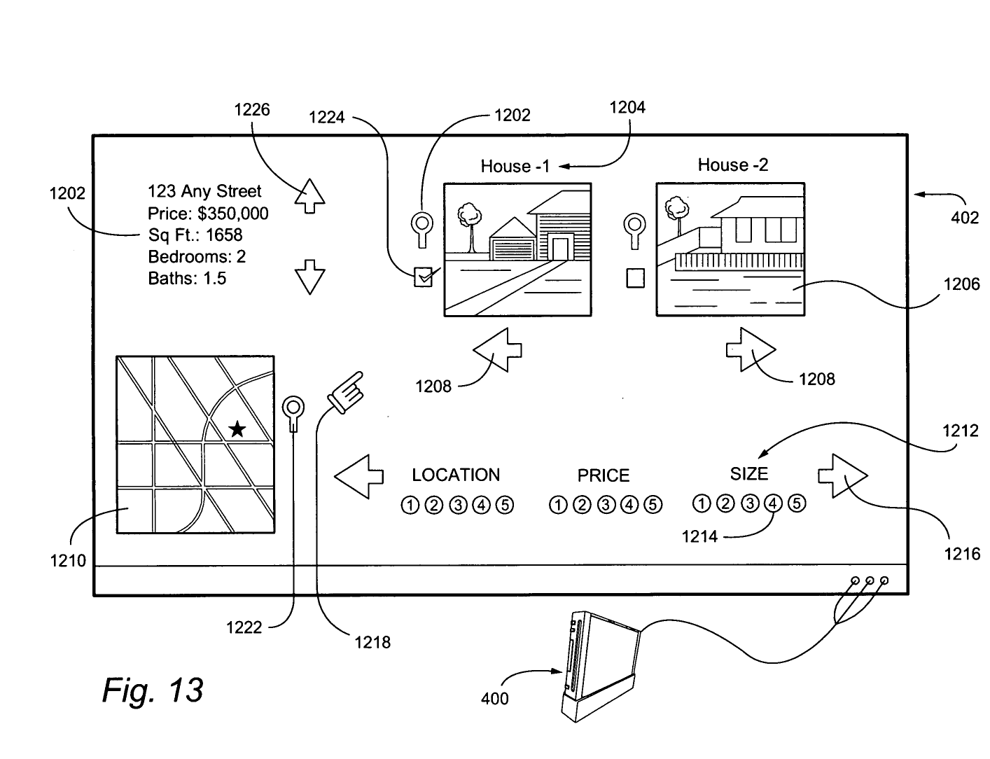

FIG. 13 shows an exemplary illustrative non-limiting implementation of a screen on a display 402 attached to a game apparatus 400 such as the Nintendo Wii® game system. The game apparatus 400 executes a program which enables the user to transfer data from the portable machine 10 to the game apparatus 400. The transferred data includes data wirelessly received by the portable machine 10 from the transmission device 291. The user transfers the file from the portable machine 10 to the game apparatus 400 wirelessly, or by removing a memory card 17 from the portable machine 10 and enabling the game apparatus 400 to read the memory card 17. Alternatively, the portable machine 10 may be connected to the game apparatus 400 via a wire. In addition to enabling data transfer, the program executed by the game apparatus 400 can provide information about the house buying process (e.g., information on mortgages, closing of a real estate contract, etc.) in general. Similar information may optionally be displayed by the portable machine 10.

The display 402 connected to the game apparatus 400 is typically much larger (e.g., 100× or larger) than the display 11 or 12 of the portable machine 10. The display 402 is thus able to show a greater amount of information than can be typically shown on display 11 or 12 and/or text and photographs in a larger form or with a greater resolution. The larger display 402 can also show data and photographs of multiple houses in a single screen, thereby allowing the user to perform a side-by-side comparison.

The display 402 may thus show a list of the information 1202 about the house, such as address, price, etc. If there is more information 1202 than can be seen in a particular viewing frame, arrows 1226 can be used to scroll up and down. User manipulation of the cursor 1218 selects a particular arrow. A controller 407 provided to the game apparatus 400 controls the cursor 1218.

The screen shown in display 402 also shows a map 1210 of the house location. This screen thus allows the user to see where the house is located in relation to schools, major highways, etc. A user may zoom in and out of this map using a magnifying tool 1222.

In addition to printed information about a location, a plurality of photographs 1206 may also be available. A user scrolls between photographs using arrows 1208. A user may magnify the photographs or select certain photographs for later viewing via tools 1222 and 1224, respectively. By selecting relevant pictures via tool 1221, the user may evaluate a house without having to review photographs which are not deemed useful. Labels 1204 provided with the photographs enable the user to know what room, etc. is being shown in a given photograph.

A rating system 1212, 1214 may also be provided with each listing. The rating system allows a user to rate particular features of a listing and later sort through numerous listings pursuant to that rating. The rating system includes one or more category names 1212 and an exemplary rating scale 1214 of 1-5. However, any suitable labeling/scale could be used. The user may see different and additional ratings via manipulation of the arrows 1216.

Portions of the information shown in the screen illustrated in FIG. 13 may also be shown on the displays 11 and/or 12 of the portable machine 10, subject to its size and resolution limitations. The display may be accomplished by the portable machine 10 via execution of the program stored in memory card 17 or an internal memory.

As discussed above, the transmission device 291 wirelessly transmits data relating to the advertised item (e.g., house for sale) to a portable machine 10. The memory 303 of the transmission device 291 stores the data at least prior to this wireless transmission. The memory 303 receives the data wirelessly through the data reception section 302, via a wired connection or from a memory card read by the memory card reader 305. The data received wirelessly by the data reception section 302, via a wired connection, or via the memory card reader 305 may be generated for example by a game apparatus 400.

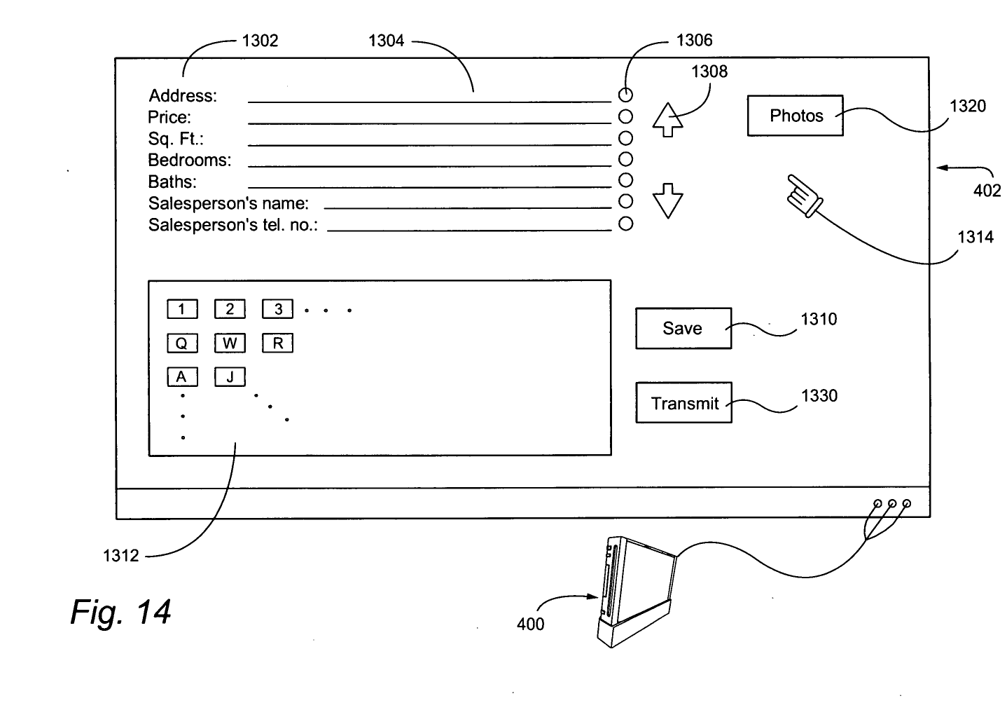

FIG. 14 shows a first exemplary illustrative non-limiting implementation of a screen shown on a display 402 connected to a game apparatus 400 for generating data to be communicated to memory 303 for subsequent transmission by the wireless transmission device 291. The screen enables a variety of information 1302 to be entered by type. If the game apparatus 400 is not provided with actual keyboard, an on-screen keyboard 1312 may be provided for information entry using pointer 1314. In this case, the user selects a category by clicking an adjacent button 1306 and then enters the information on the on-screen keyboard 1312 using the pointer 1314. A user may manipulate controller 407 to control the pointer 1314. Additional categories can be viewed by using the scrolling arrows 1308. Other data such as digital photographs of the house may be attached via selection of on-screen button 1320. Once the information is completed, the user can save the information (e.g., save to a memory card) by clicking on 1310 and/or transmit the information directly to the transmission device 291 wirelessly or via a connection wire.

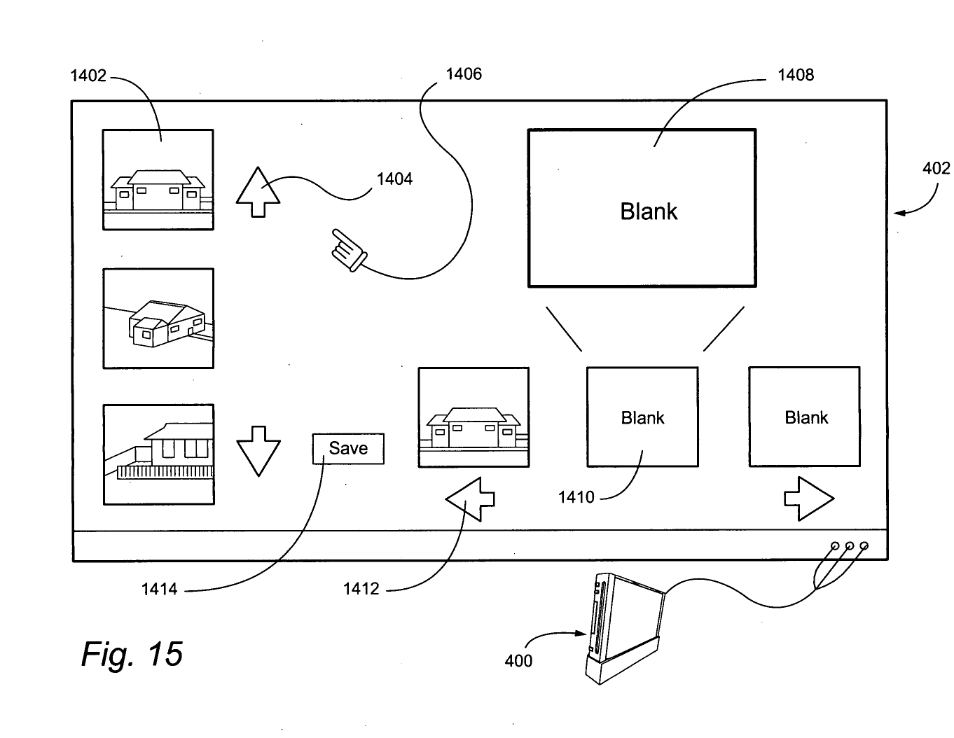

FIG. 15 shows a second exemplary illustrative screen which may be displayed on the display 402. This screen enables the user to upload photographs of the house and may be launched via user selection of button 1320 in the screen illustrated in FIG. 14. The user first takes digital photographs using a camera or scans a photograph into digital form. Then, through a wired or wireless connection, or by removing the memory card from the camera and inserting it in the game apparatus 400, the user transfers the photographs 1402 over to the game apparatus 400.

The display shows the photographs 1402 and enables the user to scroll through them using arrows 1404 selectable by cursor 1406. When the user has a photograph that should be put in a slide show, the user can, for example, drag the photograph from the display area 1402 to the next blank slide 1408. This photograph will then be placed in position in the slideshow 1410. The slideshow 1410 can be seen as it is being built by scrolling with arrows 1412. Once the user has built up the desired information, he can save the assemble slide show by using the save button 1414 and attach it to related textual information such as that entered via the screen 1302. All of this information may then be organized into a pre-fabricated format by the application being executed by the game apparatus 400 and then transferred wirelessly, or via wired connection or memory card to the transmission device 291 for subsequent transmission to a portable machine 10.

Additional features for generating the information could also be provided. The game apparatus 400 may access, via an internet connection, a mapping site and download a map of the designated house's surrounding area. Other downloadable information such as video footage for a virtual tour of the house may also be incorporated. In short, any information useful to advertise a particular product may be included. This information may be organized into any one of a number of user-selectable templates.

While the invention has been described in connection with exemplary illustrative non-limiting implementations, it is to be understood that the invention is not to be limited to the disclosed implementations. To the contrary, the invention is intended to cover various modifications and equivalent arrangements included within the scope of the appended claims.

I claim:

1. A download station comprising:
a sign advertising a product;
a memory area that stores data relating to the product, the data including at least visually displayable information; and
a transmission device, associated with the sign, that wirelessly transmits the data from the memory area to at least one portable machine.

2. The download station of claim 1, wherein the product is a house for sale.

3. The download station of claim 1, further comprising a receiver that wirelessly receives the data relating to the product for subsequent storage of the data in the memory area.

4. The download station of claim 1, further comprising a reader that reads a memory card storing the data relating to the product for subsequent storage of the data in the memory area.

5. The download station of claim 1, further comprising a user-operable switch for activating repeated wireless transmission of the data from the transmission device.

6. The download station of claim 1, further comprising a processor that processes a request for the data relating to the product, the request being received from the portable machine.

7. The download station of claim 6, wherein processing the request by the processor initiates the wireless transmission of the data relating to the product by the transmission device.

8. The download station of claim 1, wherein the portable machine is a hand-held video game machine.

9. A method of wirelessly downloading data relating to a product being advertised by a sign, the method comprising:
storing the data relating to the product in a memory area, the data including at least visually displayable information; and
wirelessly transmitting the data from the memory area to at least one portable machine via a transmission device associated with the sign.

10. The method of claim 9, wherein the product is a house for sale.

11. The method of claim 9, further comprising wirelessly receiving the data relating to the product for storage in the memory area.

12. The method of claim 9, further comprising repeatedly wirelessly transmitting the data from the memory area via the transmission device.

13. The method of claim 9, further comprising reading a memory card storing the data relating to the product for storage of the data in the memory area.

14. The method of claim 9, further comprising processing a request for the data relating to the product, the request being received from the portable machine.

15. The method of claim 14, wherein processing the request results in initiating the wireless transmission of the data from the memory area via the transmission device.

16. The method of claim 9, wherein the portable machine is a hand-held video game machine.

17. A system for wirelessly downloading data including at least visually displayable information related to a product, the system comprising:
a sign advertising the product;
a transmission device, coupled to the sign, that wirelessly transmits the data including the at least visually displayable information related to the product; and
a portable machine that receives the data wirelessly transmitted from the transmission device, the portable machine having a display for displaying the visually displayable information.

18. The system of claim 17, wherein the product is a house for sale.

19. The system of claim 17, further comprising a computer system that generates the data by formatting data received by the computer system into a pre-fabricated form.

20. The system of claim 19, wherein the computer system wirelessly transmits the generated data to a memory area which is readable by a processor associated with the transmission device.

21. The system of claim 19, wherein the computer system transfers the generated data to a memory card with is readable by a processor associated with the transmission device.

22. The system of claim 17, further comprising a computer system which is capable of receiving data from the portable machine, the computer system being attachable to a display for displaying visually displayable information of the data received from the portable machine.

23. The system of claim 17, wherein the portable machine includes a processor which executes a routine for detecting an existence of data wirelessly transmitted from the transmission device, and automatically downloading the data transmitted from the transmission device upon detection.

24. The system of claim 17, wherein the portable machine includes a processor which executes a routine for detecting an existence of data transmitted from the transmission device, and automatically displaying a prompt on the display of the portable machine to prompt whether the data wirelessly transmitted from the transmission device should be downloaded to the portable machine.

25. The system of claim 17, further comprising a processor, associated with transmission device, that processes a request for the data including the at least visually displayable information related to the product, the request being wirelessly received from the portable machine.

26. The system of claim 25 wherein the processing of the request from the portable machine includes initiating wireless transmission of the data including the at least visually displayable information related to the product from the transmission device.

27. The system of claim 17, wherein the portable machine is a hand-held video game machine.

28. A portable apparatus for wirelessly receiving, from a transmission device associated with a sign, visually displayable information relating to a product which is being advertised on the sign, the portable apparatus comprising:
a processor for executing a routine for detecting an existence of the information, relating to the product advertised on the sign, which is transmitted from the transmission device, and automatically generating a prompt indicating whether or not the information transmitted from the transmission device should be downloaded in response to detection of the existence of information transmitted from the transmission device; and
a display for displaying the prompt.

29. The portable apparatus of claim 28, wherein the product is a house for sale.

30. A portable apparatus for wirelessly receiving, from a transmission device associated with a sign, visually displayable information relating to a product which is being advertised on the sign, the portable apparatus comprising:
a processor for executing a routine for detecting an existence of the information, relating to the product advertised on the sign, which is transmitted from the transmission device, and automatically downloading the visually displayable information relating to the product advertised on the sign upon detection of the existence of the information; and
a display for automatically displaying the visually displayable information relating to the product advertised on the sign.

31. The portable apparatus of claim 30, wherein the product is a house for sale.

32. A portable apparatus for wirelessly receiving, from a transmission device associated with a sign, visually displayable information relating to a product which is being advertised on the sign, the portable apparatus comprising:
a processor for executing a routine for generating a request to wirelessly receive, from the transmission device, the visually displayable information relating to the product advertised on the sign; and
a display for displaying the visually displayable information relating to a product which is being advertised on the sign after receipt of the displayable information from the transmission device.

33. The portable apparatus of claim 32, wherein the product is a house for sale.

34. The portable apparatus of claim 32, wherein the processor executes the routine for generating the request to receive in response to a user-generated request.
